(19) United States
(12) Patent Application Publication
(10) Pub. No.: US 2007/0075823 A1
(43) Pub. Date: Apr. 5, 2007

(54) Thermistor

(75) Inventor: Tsuyoshi Sugiyama, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/525,922

(22) Filed: Sep. 25, 2006

(30) Foreign Application Priority Data
Sep. 30, 2005 (JP) P2005-289337

(51) Int. Cl. H01C 7/13

(52) U.S. Cl. 338/22 R

(57) ABSTRACT

A thermistor comprising a pair of substrates; conductor plates for electrically connecting a pair of electrodes, the conductor plates being fixed on inner faces of the pair of substrates respectively; and a matrix resin layer disposed between the pair of substrates; wherein the conductor plates are disposed so as to be at least partially overlapping.

### BACKGROUND OF THE INVENTION

1. Field of the Invention

The present invention relates to a thermistor (P-PTC) having so-called PTC (Positive Temperature Coefficient) characteristics.

2. Related Background Art

A characteristic of a thermistor having organic positive characteristics (P-PTC) is that its electrical resistance increases sharply as the temperature rises within a specific temperature region, that is, it has PTC (Positive Temperature Coefficient) characteristics, and these thermistors have been used in battery pack protection elements for various kinds of portable device, as well as in temperature fuses, temperature switches, and so forth.

One thermistor of this type that has been commonly known up to now is produced by mixing nickel powder, carbon black, or another such conductive filler into a matrix resin composed of a thermoplastic resin or thermosetting resin, molding this in the form of a plate or block, and providing this product with a pair of electrodes (Japanese Laid-Open Patent Application 2000-82604, paragraph 0029, FIG. 1).

With a thermistor such as this, since the pair of electrodes are electrically connected via the conductive filler mixed into the matrix resin, the matrix resin itself generates joule heat and its temperature rises when power is supplied to the pair of electrodes. Once the matrix resin reaches a specific temperature and thermally expands significantly, contact through the conductive filler is severed, causing a rapid increase in the electrical resistance between the pair of electrodes.

### SUMMARY OF THE INVENTION

With the conventional thermistor described in Japanese Laid-Open Patent Application 2000-82604, the PTC characteristics and the initial resistance between the pair of electrodes vary greatly with the shape, added amount, dispersion state, and so forth of the conductive filler mixed into the matrix resin, and this makes it difficult to obtain PTC characteristics with a stably low initial resistance and a large change in resistance.

The thermal expansion of the matrix resin decreases greatly from the original value of the resin because a conductive filler such as carbon black that has a small coefficient of linear expansion is admixed in a large quantity. Consequently, a material with a large coefficient of linear expansion must be used as the matrix resin material. Nevertheless, because resin materials with a large coefficient of linear expansion generally have low heat resistance, defects in a reflow step in which the thermistor is mounted to a substrate surface may occur frequently.

In view of this, it is an object of the present invention to provide a thermistor with which PTC characteristics having a stably low initial resistance and a large change in resistance can be easily obtained, and furthermore heat resistance during reflow can be improved.

The thermistor according to the first invention is a thermistor comprising: a pair of substrates; conductor plates for electrically connecting a pair of electrodes, the conductor plates being fixed on inner faces of the pair of substrates respectively; and a matrix resin layer disposed between the pair of substrates. The conductor plates are disposed so as to be at least partially overlapping with each other.

With the thermistor according to the first invention, since the conductor plates that electrically connect the pair of electrodes are fixed to the inner faces of the pair of substrates and are disposed so as to be at least partially overlapping, a stably low initial resistance value is easily obtained as the initial resistance value between the pair of electrodes. If an electric current between the pair of electrodes generates joule heat so that the matrix resin heats up to a specific temperature and greatly expands thermally, the conductor plates will move apart, and this instantly cuts off the electrical connection between the pair of electrodes. Accordingly, there is a sharp increase in the electrical resistance between the pair of electrodes, and PTC characteristics with a large change in resistance can be easily obtained.

The thermistor according to the second invention is a thermistor comprising: a pair of substrates; a pair of conductor plates for electrically connecting a pair of electrodes, the pair of conductor plates being fixed on inner faces of the pair of substrates respectively; and a matrix resin layer disposed between the pair of substrates. The pair of conductor plates are disposed opposing each other so as to be in contact with each other in the initial state, and move apart along with thermal expansion of the matrix resin.

With the thermistor according to the second invention, since the pair of conductor plates that electrically connect the pair of electrodes are in contact with each other in their initial state, a stably low initial resistance value is easily obtained as the initial resistance value between the pair of electrodes. If an electrical current between the pair of electrodes generates joule heat so that the matrix resin heats up to a specific temperature and greatly expands thermally, the pair of conductor plates will move apart, and this instantly cuts off the electrical connection between the pair of electrodes. Accordingly, there is a sharp increase in the electrical resistance between the pair of electrodes, and PTC characteristics with a large change in resistance can be easily obtained.

With the thermistor according to the second invention, the respective conductor plates may be integral with the respective electrodes. Also, the respective conductor plates may be formed in a plate shape that comes into contact with the respective electrodes.

Here, PTC characteristics with an even greater change in resistance can be obtained if the volumetric ratio of the conductor plates to a reference volume obtained by adding the conductor plates to the matrix resin is from 1 to 30%, and preferably from 1 to 20%, and more preferably from 1 to 10%.

With the thermistor according to the first invention, since the conductor plates that electrically connect the pair of electrodes are fixed to the inner faces of the pair of substrates and are disposed so as to be at least partially overlapping, a stably low initial resistance value can be easily obtained as the initial resistance value between the pair of electrodes. If an electrical current between the pair of electrodes generates joule heat so that the matrix resin heats up to a specific temperature and greatly expands thermally, the conductor plates will move apart, and this instantly cuts off the electrical connection between the pair of electrodes, so PTC characteristics with a large change in resistance can be easily obtained. Because no conductive filler with a small coefficient of linear expansion that would decrease the thermal expansion of the matrix resin is mixed into this resin, heat resistance in a reflow step can be increased by using a matrix resin with higher heat resistance.

With the thermistor according to the second invention, since the pair of conductor plates that electrically connect the pair of electrodes are in contact with each other in their initial state, a stably low initial resistance value is easily obtained as the initial resistance value between the pair of electrodes. If an electrical current between the pair of electrodes causes the matrix resin to heat up to a specific temperature and greatly expand thermally, the pair of conductor plates will move apart, and this instantly cuts off the electrical connection between the pair of electrodes, so PTC characteristics with a large change in resistance can be easily obtained. Because no conductive filler with a small coefficient of linear expansion that would decrease the thermal expansion of the matrix resin is mixed into this resin, heat resistance in a reflow step can be increased by using a matrix resin with higher heat resistance.

### BRIEF DESCRIPTION OF THE DRAWINGS

FIG. 1 is a perspective view schematically illustrating the structure of the thermistor according to a first embodiment of the present invention;

FIG. 2 is a vertical section of the thermistor shown in FIG. 1;

FIG. 3 is an perspective view schematically illustrating the structure of the thermistor according to a second embodiment of the present invention;

FIG. 4 is a vertical section of the thermistor shown in FIG. 3; and

FIG. 5 is a vertical section of a thermistor with a different conductor plate layout from that shown in FIG. 4.

### DESCRIPTION OF THE PREFERRED EMBODIMENTS

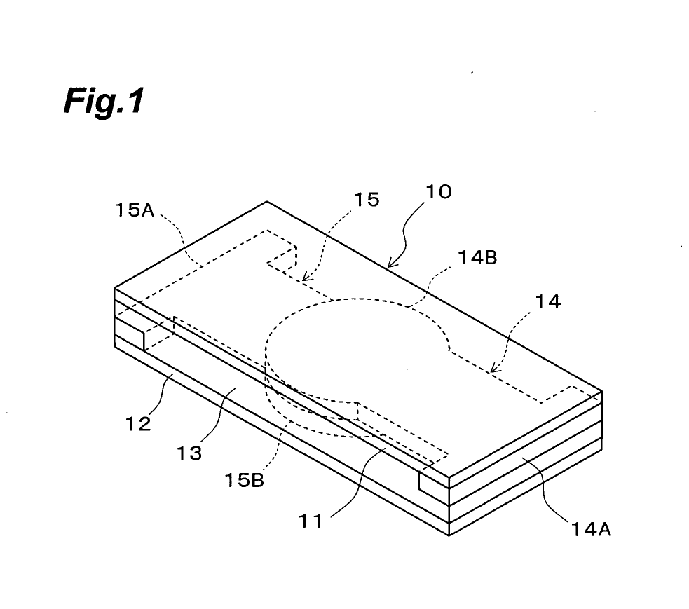

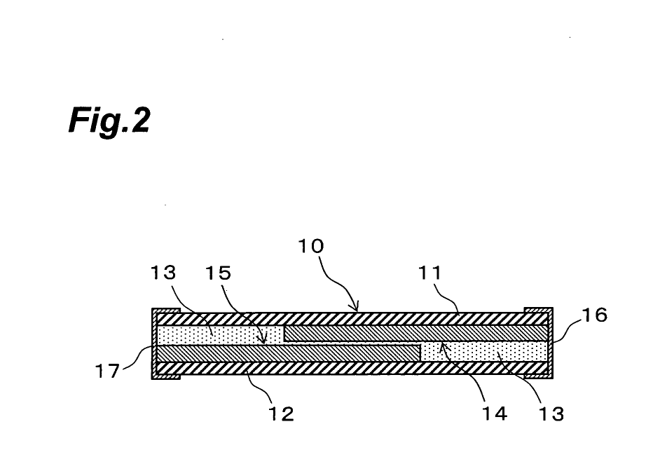

Embodiments of the thermistor according to the present invention will now be described through reference to the drawings. Provided that the present invention in not limited to the embodiments described below. Here, FIG. 1 is an perspective view schematically illustrating the structure of the thermistor according to a first embodiment of the present invention, and FIG. 2 is a vertical section of the thermistor shown in FIG. 1.

The thermistor 10 of the first embodiment illustrated in FIGS. 1 and 2 is a thermistor 10 with organic positive characteristics, which is abbreviated as PTC (Positive Temperature Coefficient) characteristics, and has a cross sectional structure in which a matrix resin layer 13 is provided between an upper substrate 11 and a lower substrate 12. Overall, the thermistor is formed into a rectangular plate shape measuring about 4.5 mm on the long side, 3.0 mm on the short side, and 0.6 mm thick.

The upper substrate 11 and lower substrate 12 are obtained, for example, by hot-molding sheets of glass epoxy prepreg about 200 μm thick in a vacuum press. An upper conductor plate 14 about 100 μm thick is provided in advance to the inner face of the upper substrate 11, and a lower conductor plate 15 about 100 μm thick is provided in advance to the inner face of the lower substrate 12. The upper conductor plate 14 and lower conductor plate 15 are composed of a metal with good electrical conductivity, such as gold, silver, copper, or nickel. The material of the upper substrate 11 and lower substrate 12 can be selected as needed and may be either conductive or insulating.

The upper conductor plate 14 is composed of a nickel foil that is disposed on one side of the glass epoxy prepreg constituting the upper substrate 11, and these are vacuum-pressed together, after which this product is molded in a specific planar shape by etching, for example. This upper conductor plate 14 comprises an electrode component 14A that extends along one of the short sides of the thermistor 10, and a substantially circular conductor component 14B that is disposed at the center of the thermistor 10, with these two components being formed as a continuous, integrated plate.

The lower conductor plate 15 is formed in the same planar shape by the etching of a nickel foil in the same manner as the upper conductor plate 14. Specifically, the lower conductor plate 15 comprises an electrode component 15A that extends along the other short side of the thermistor 10, and a substantially circular conductor component 15B that is disposed at the center of the thermistor 10, with these two components being formed as a continuous, integrated plate.

The fixing state of the upper conductor plate 14 to the upper substrate 11, and the fixing state of the lower conductor plate 15 to the lower substrate 12 may be either direct or indirect.

The conductor component 14B of the upper conductor plate 14 and the conductor component 15B of the lower conductor plate 15 are in planar contact with each other in the matrix resin layer 13 in their initial state. Accordingly, it is easy to obtain a stably low initial resistance value as the initial resistance value between the electrode component 14A of the upper conductor plate 14 and the electrode component 15A of the lower conductor plate 15.

The matrix resin layer 13 is a layer obtained by filling the space between the upper substrate 11 and the lower substrate 12 with a suitable thermoplastic resin (such as a polyethylene, imide resin, or liquid crystal polymer) or thermosetting resin (such as an epoxy resin, urethane resin, or silicone resin) that can be thermally expanded by joule heat, and then curing this resin. In this embodiment, the matrix resin layer 13 is formed by an epoxy resin with high heat resistance and a large coefficient of linear expansion.

Here, the volumetric ratio of the upper conductor plate 14 and lower conductor plate 15 to a reference volume obtained by adding the upper conductor plate 14 and lower conductor plate 15 to the matrix resin layer 13 is about 1 to 30%, for example.

An electrode 16 that has a square U-shaped cross section and that electrically connects to the electrode component 14A of the upper conductor plate 14 is mounted on one of the short sides of the thermistor 10 in the first embodiment, and an electrode 17 that has a square U-shaped cross section and that electrically connects to the electrode component 15A of the lower conductor plate 15 is mounted on the other short side.

The thermistor 10 in the first embodiment constituted as above is used in battery pack protection elements for various kinds of portable device, as well as in temperature fuses, temperature switches, and so forth, utilizing PTC (Positive Temperature Coefficient) characteristics such that electrical resistance increases sharply as the temperature rises within a specific temperature region.

When the thermistor 10 of the first embodiment is used in an application such as this, if joule heat is generated by an electrical current between the pair of electrodes 16 and 17, and the matrix resin layer 13 is heated up to a specific temperature so that it undergoes enough thermal expansion, the conductor component 14B of the upper conductor plate 14 and the conductor component 15B of the lower conductor plate 15 move away from each other as shown in FIG. 2, at which point the conduction is instantly cut off. As a result, PTC (Positive Temperature Coefficient) characteristics are exhibited in which there is a sharp rise in the electrical resistance between the pair of electrodes 16 and 17, and there is a large change in the resistance value.

With the thermistor 10 of the first embodiment, since no conductive filler with a small coefficient of linear expansion that would decrease the thermal expansion of the matrix resin layer 13 is mixed into this layer, a material with higher heat resistance can be used as the resin material of the matrix resin layer 13. As a result, heat resistance will be higher during a reflow step in which the thermistor 10 is mounted on the substrate surface, allowing the PTC characteristics inherent to the thermistor 10 to be fully exhibited.

Furthermore, since the upper conductor plate 14 and lower conductor plate 15 embedded in the matrix resin layer 13 of the thermistor 10 have almost no effect on the PTC characteristics of the thermistor 10, even when identical thermistors 10 are mass produced, it will be easy to obtain consistent PTC characteristics for all the thermistors 10.

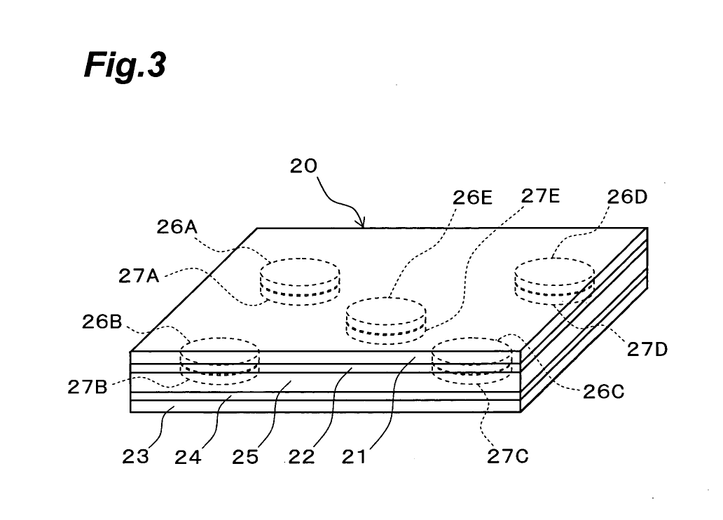

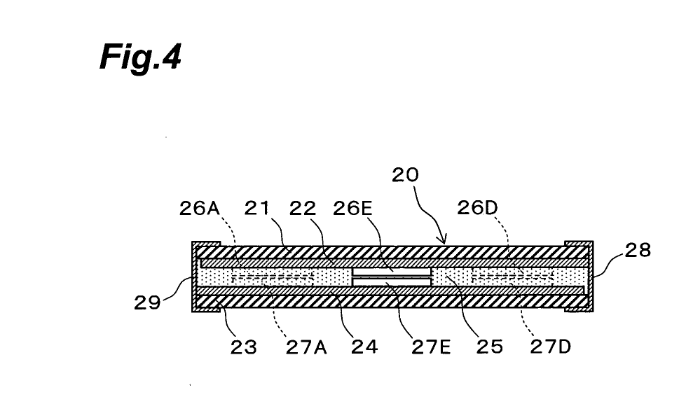

FIGS. 3 and 4 illustrate a thermistor 20 according to a second embodiment of the present invention. This thermistor 20 has a cross sectional structure in which a matrix resin layer 25 is provided between an upper electrode layer 22 that has been provided in advance to the inner face of an upper substrate 21, and lower electrode layer 24 that has been provided in advance to the inner face of a lower substrate 23. Overall, the thermistor is formed into a rectangular plate shape measuring about 4.5 mm on the long side, 3.0 mm on the short side, and 0.6 mm thick.

The upper substrate 21 and lower substrate 23 are obtained, for example, by hot-molding sheets of glass epoxy prepreg about 200 μm thick in a vacuum press. The upper electrode layer 22, which is composed of a nickel foil about 100 μm thick, is provided by vacuum press in advance to the inner face of the upper substrate 21, and similarly, the lower electrode layer 24, which is composed of a nickel foil about 100 μm thick, is provided by vacuum press in advance to the inner face of the lower substrate 23.

Here, on the inner face of the upper electrode layer 22 a plurality of (for example five) upper conductor plates 26A to 26E that are formed in a disk shape are disposed in the five pattern of dice, for example. These upper conductor plates 26A to 26E can be produced by coating the inner face of the upper electrode layer 22 by inkjet printing or screen printing with a conductive paste of gold, silver, copper, nickel, or the like, but there are no restrictions on how they are produced as long as they are good conductors.

Meanwhile, on the inner face of the lower electrode layer 22 five disk-shaped lower conductor plates 27A to 27E that are disposed facing and in planar contact with the respective upper conductor plates 26A to 26E are provided in the same manner as the upper conductor plates 26A to 26E.

The upper conductor plates 26A to 26E and lower conductor plates 27A to 27E are embedded in the matrix resin layer 25, which is the same as the matrix resin layer 13 in the thermistor 10 of the first embodiment, and these upper conductor plates 26A to 26E and lower conductor plates 27A to 27E are in planar contact with each other, respectively, in their initial state. Accordingly, it is easy to obtain stably low initial resistance as the initial resistance value between the upper electrode layer 22 and the lower electrode layer 24.

Here, the total volumetric ratio of the upper conductor plates 26A to 26E and the lower conductor plates 27A to 27E to a reference volume obtained by adding the upper conductor plates 26A to 26E and lower conductor plates 27A to 27E to the matrix resin layer 25 is about 1 to 30%, for example.

An electrode 28 that has a square U-shaped cross section and that electrically connects to the upper electrode layer 22 is mounted on one of the short sides of the thermistor 20 in the second embodiment, and an electrode 29 that has a square U-shaped cross section and that electrically connects to the lower electrode layer 24 is mounted on the other short side.

With the thermistor 20 of the second embodiment constituted as above, if joule heat is generated by an electrical current between the pair of electrodes 28 and 29, and the matrix resin layer 25 is heated up to a specific temperature so that it undergoes enough thermal expansion, upper conductor plates 26A to 26E and lower conductor plates 27A to 27E move away from each other as shown in FIG. 4, at which point the conduction is instantly cut off. As a result, PTC (Positive Temperature Coefficient) characteristics are exhibited in which there is a sharp rise in the electrical resistance between the pair of electrodes 28 and 29, and there is a large change in the resistance value.

With the thermistor 20 of the second embodiment, since no conductive filler with a small coefficient of linear expansion that would decrease the thermal expansion of the matrix resin layer 25 is mixed into this layer, a material with higher heat resistance can be used as the resin material of the matrix resin layer 25. As a result, heat resistance will be higher during a reflow step in which the thermistor 20 is mounted on the substrate surface, allowing the PTC characteristics inherent to the thermistor 20 to be fully exhibited.

Furthermore, since the upper conductor plates 26A to 26E and lower conductor plates 27A to 27E embedded in the matrix resin layer 25 of the thermistor 20 have almost no effect on the PTC characteristics of the thermistor 20, even when identical thermistors 20 are mass produced, it will be easy to obtain consistent PTC characteristics for all the thermistors 20.

The thermistor according to the present invention is not limited to or by the embodiments given above. For instance, with the thermistor 10 of the first embodiment illustrated in FIGS. 1 and 2, the upper conductor plate 14 and lower conductor plate 15 may be formed by plating with gold, silver, copper, nickel, or another such metal, or may be formed by inkjet printing or screen printing with a conductive past of gold, silver, copper, nickel, or the like.

Also, the conductor component 14B of the upper conductor plate 14 and the conductor component 15B of the lower conductor plate 15 need not have a circular planar shape, and can instead have an elliptical shape, tetrahedral shape, or any other suitable planar shape.

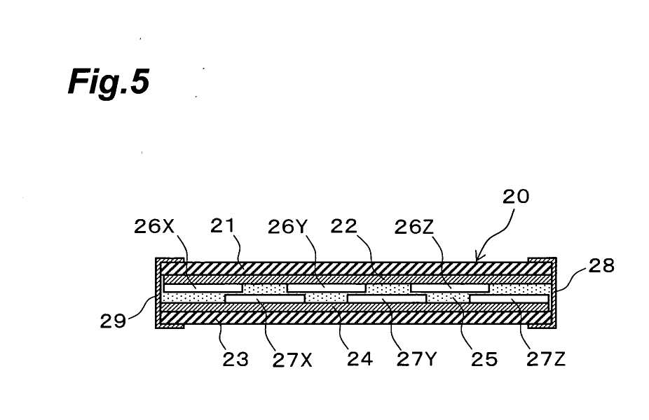

The arrangement of the upper conductor plates 26A to 26E and lower conductor plates 27A to 27E illustrated in FIGS. 3 and 4 may be changed to an arrangement such that upper conductor plates 26X to 26Z and lower conductor plates 27X to 27Z are in alternating planar contact as shown in FIG. 5.

There are no particular restrictions on the resin material that constitutes the matrix resin layers 13 and 25 of the thermistors 10 and 20, and can be any thermosetting resin or thermoplastic resin used in conventional thermistor elements, and may be either a single resin or a mixture. A resin material containing a thermosetting resin will exhibit better heat resistance than a resin material containing a thermoplastic resin, whereas a resin material containing a thermoplastic resin will produce a greater change in resistance as the temperature rises than a resin material containing a thermosetting resin.

Specific examples of thermosetting resins include epoxy resins, polyimide resins, unsaturated polyester resins, silicone resins, polyurethane resins, and phenol resins. Of these, an epoxy resin is preferred because it will afford a greater resistance change and better heat resistance.

The thermosetting resin preferably has a molecular weight (as the weight average molecular weight Mw) of from 300 to 10000. A single kind of these thermosetting resins can be used, or two or more kinds may be used together, or the resin may have a structure in which different kinds of thermosetting resin have been crosslinked.

Meanwhile, a crystalline polymer is preferably used as a thermoplastic resin. The melting point of this thermoplastic resin is preferably from 70 to 200° C. in order to prevent element deformation, flow caused by the melting of the thermoplastic resin during operation, and so forth.

Specific examples of thermoplastic resins include (1) polyolefins (such as polyethylene), (2) copolymers made up of repeating units based on olefinic unsaturated monomers containing at least one type of polar group, and at least one type of olefin (such as ethylene or propylene) (examples include ethylene/vinyl acetate copolymers), (3) halogenated vinyl and vinylidene polymers (examples include polyvinyl chloride, polyvinyl fluoride, and polyvinylidene fluoride), (4) polyamides (such as 12-nylon), (5) polystyrenes, (6) polyacrylonitriles, (7) thermoplastic elastomers, (8) polyethylene oxides, polyacetals, (9) thermoplastic modified cellulose, (10) polysulfones, and (11) polymethyl (meth)acrylates.

More specific examples include (1) high-density polyethylene (such as Hizex 2100JP (trade name of Mitsui Chemical), and Marlex 6003 (trade name of Phillips)), (2) low-density polyethylene (such as LC500 (trade name of Nippon Polychem), and DYMH-1 (trade name of Union Carbide)), (3) medium-density polyethylene (such as 2604M (trade name of Gulf)), (4) ethylene/ethyl acrylate copolymers (such as DPD6169 (trade name of Union Carbide)), (5) ethylene/acrylic acid copolymers (such as EAA455 (trade name of Dow Chemical)), (6) hexafluoroethylene/tetrafluoroethylene copolymers (such as FEP100 (trade name of DuPont)), and (7) polyvinylidene fluorides (such as Kynar 461 (trade name of Penvalt)).

Preferably, this thermoplastic resin has a weight average molecular weight Mw of 10000 to 5000000. These thermoplastic resins may be used singly or in combinations of two or more types, and resins having a structure in which different kinds of thermoplastic resins are crosslinked may also be used.

### EXAMPLE 1

As Example 1, a thermistor having a structure illustrated in FIGS. 1 and 2 was manufactured, and the initial resistance (mΩ) at 25° C. between the electrode 16 and electrode 17 thereof, the change in resistance (log 10), the resin glass transition point (° C.)/DMA, and the resistance (mΩ) after reflow at 260° C. were measured.

The upper substrate 11 and the lower substrate 12 of the thermistor 10 in Example 1 were hot-molded for 2 hours at a temperature of 180° C. in a 3 MPa vacuum press. The matrix resin layer 13 was prepared by blending an epoxy resin (trade name E4080, an epoxy resin with an epoxy equivalent of 167 g, made by Asahi Chemical Industries) and a flexible epoxy resin (trade name E4005, a flexible epoxy resin with an epoxy equivalent of 510 g, made by Asahi Chemical Industries) in a weight ratio of 2/1, and then adding an equivalent amount of methyltetrahydrophthalic anhydride (trade name B570, a curing agent with an acid anhydride equivalent of 160 g, made by Dainippon Ink & Chemicals) as a curing agent to this mixture. The matrix resin layer 13 was then heat cured for 2 hours at a temperature of 180° C. and a pressure of 0.1 MPa.

Meanwhile, as Comparative Example 1, a thermistor was manufactured by disposing nickel foil electrodes on both sides of a matrix resin layer into which a conductive filler had been mixed, and then heat curing this product, and the same categories as in the example, namely, the initial resistance (mΩ) at 25° C. between the electrodes, the change in resistance (log 10), the resin glass transition point (° C.)/DMA, and the resistance (mΩ) after reflow at 260° C., were measured for this thermistor.

The thermistor of Comparative Example 1 had the same dimensions as the thermistor 10 of Example 1 (4.5 mm on the long side, 3.0 mm on the short side, and 0.5 mm thick), and the thickness of the nickel foil used for the electrodes was 25 μm. The matrix resin layer was heat cured for 2 hours at 150° C.

The matrix resin in the thermistor of Comparative Example 1 was prepared by blending an epoxy resin (trade name E4080, an epoxy resin with an epoxy equivalent of 167 g, made by Asahi Chemical Industries) and a flexible epoxy resin (trade name E4005, a flexible epoxy resin with an epoxy equivalent of 510 g, made by Asahi Chemical Industries) in a weight ratio of 2/1, and then adding an equivalent amount of methyltetrahydrophthalic anhydride (trade name B570, a curing agent with an acid anhydride equivalent of 160 g, made by Dainippon Ink & Chemicals) as a curing agent to this mixture. A curing promoter (2E4MZ, a trade name of Shikoku Chemicals) in an amount of 2 wt % and a filament-form nickel filler (trade name Type 255, a conductive filler with an average particle size of 2.5 μm, made by INCO) in an amount of 400 wt % were stirred and mixed with this matrix resin mixture in an amount of 100 wt %, which produced a matrix resin layer.

The measurement results are given in Table 1 below. The change in resistance (log 10) was 7 in Example 1 and 1 in Comparative Example 1, which makes it clear that the PTC characteristics obtained in Example 1 represented a far larger change in resistance than that in Comparative Example 1. Also, the resistance after reflow at 260° C. was 10 mΩ in Example 1 and 20 mΩ in Comparative Example 1, which makes it clear that the resistance after reflow obtained in Example 1 was only half that in Comparative Example 1.

TABLE 1

| | | Comparative |
|---|---|---|
| | Example 1 | Example 1 |
| Initial resistance at 25° C. (mΩ) | 5 | 5 |
| Change in resistance (log10) | 7 | 1 |
| Resin glass transition point | 100 | 100 |
| (° C.)/DMA | | |
| Resistance after reflow at 260° C. | 10 | 20 |
| (mΩ) | | |

What is claimed is:

1. A thermistor comprising:
a pair of substrates;
conductor plates for electrically connecting a pair of electrodes, the conductor plates being fixed on inner faces of the pair of substrates respectively; and
a matrix resin layer disposed between the pair of substrates;
wherein the conductor plates are disposed so as to be at least partially overlapping.

2. A thermistor according to claim 1,
wherein the volumetric ratio of the conductor plates to a reference volume obtained by adding the conductor plate to the matrix resin is from 1 to 30%.

3. A thermistor comprising:
a pair of substrates;
a pair of conductor plates for electrically connecting a pair of electrodes, the pair of conductor plates are fixed on inner faces of the pair of substrates respectively; and
a matrix resin layer disposed between the pair of substrates;
wherein the pair of conductor plates are disposed opposing each other so as to be in contact with each other in the initial state, and move apart along with thermal expansion of the matrix resin.

4. A thermistor according to claim 3,
wherein the respective conductor plates are integral with the respective electrodes.

5. A thermistor according to claim 3,
wherein the respective conductor plates are formed in a plate shape that comes into contact with the respective electrodes.

6. A thermistor according to claim 3,
wherein the volumetric ratio of the conductor plates to a reference volume obtained by adding the conductor plate to the matrix resin is from 1 to 30%.
